(19) United States
(12) Patent Application Publication
(10) Pub. No.: US 2012/0092551 A1
(43) Pub. Date: Apr. 19, 2012

(54) LENS DRIVING DEVICE AND CAMERA MODULE

(75) Inventors: SUGURU OHISHI, Okayama (JP); HIROSHI YAMASHITA, Okayama (JP); MITSUO NAKASHIMA, Osaka (JP); SATORU OTA, Osaka (JP)

(73) Assignee: PANASONIC CORPORATION, Osaka (JP)

(21) Appl. No.: 13/267,074

(22) Filed: Oct. 6, 2011

(30) Foreign Application Priority Data
Oct. 13, 2010 (JP) 2010-230221

(51) Int. Cl. H04N 5/225; G02B 7/04

(52) U.S. Cl. 348/374; 359/824; 348/E05.024

(57) ABSTRACT

A lens driving device prevents its holder from tilting while driving the lens, and has a small number of components, low cost, and small size. The lens driving device includes a base, a holder, magnets, and magnetic plates. The base includes a projection having a hook-shaped cross section. The holder includes a rotation inhibitor which comes into contact with the projection of the base. The holder is supported to the base by one shaft. One magnetic plate is located further from the shaft than the center of the magnet is. The other magnetic plate is located closer to the shaft than the center of the magnet is. The magnetic forces generated between the magnetic plates and the magnets make the holder subjected to a torque on the shaft. The torque allows the rotation inhibitor to be slightly pressed against the projection.

### BACKGROUND

1. Technical Field

The technical field relates to a lens driving device and a camera module. The field relates, more particularly, to an autofocus lens driving device mounted on a compact camera or other similar devices, and to a camera module equipped with the lens driving device.

2. Background Art

Conventionally, mobile telephones are equipped with a camera module including a lens driving device for focus-control. The lens driving device displaces a lens along an optical axis according to a control signal, thereby controlling the focus of a subject.

For example, Japanese Patent Unexamined Publication No. 2009-69611 shows a moving-magnet type lens driving device for auto-focusing a camera lens. This lens driving device includes a holder for holding a lens, and a base. The holder has four magnets arranged around it. The base has two shafts and a coil. These shafts guide the holder to be displaced along the optical axis of the lens. The coil is located to face the magnets on the holder. The holder is driven along the optical axis of the lens by an electromagnetic driving force generated by applying a current to the coil.

In this structure, the magnetic plates are arranged around the coil. The arrangement between the magnets and the magnetic plates can be adjusted to unbalance the magnetic forces, which are exerted between the magnets and the magnetic plates, in the in-plane direction perpendicular to the optical axis of the lens. As a result, the holder is pressed against the two shafts. When the current application to the coil is stopped, the magnetic forces press the holder against the two shafts, thereby bringing the holder to a standstill.

### SUMMARY

In the above lens driving device, the holder moves along the shafts while being pressed against them. The frictional force between one shaft and one hole of the holder is different from the frictional force between the other shaft and the other hole of the holder. The difference between these frictional forces causes the holder to tilt.

In addition, the four magnets on the holder and the two shafts on the base result in an increase in the number of components, and therefore, an increase in the cost and size of the device.

The present disclosure describes a lens driving device which prevents the holder from tilting while driving a lens, and has fewer components, lower cost, and smaller size than conventional devices. The disclosure also describes a camera module including the lens driving device.

The lens driving device, according to a first aspect, includes a base; a shaft arranged on the base; a holder for holding a lens, the holder being supported by the shaft so as to be displaced in a direction parallel to the optical axis of the lens; a magnet arranged on the holder so as to sandwich the shaft; a coil arranged on the base so as to face the magnet; and a magnetic plate arranged on the base so as to face the magnet with the coil therebetween. The holder includes a first contact part, and the base includes a second contact part, the first and second contact parts coming into contact with each other in a direction where the holder rotates around the shaft. The magnetic plate is located such that the holder is subjected to a torque on the shaft by a magnetic force generated between the magnet and the magnetic plate, the torque being applied in a direction where the first contact part is pressed against the second contact part.

In the lens driving device according to this aspect, the holder moves along the single shaft, becoming less likely to be tilted than in the case of moving along two shafts. The magnet is arranged to sandwich the shaft, which has two merits. First, when a current is applied to the coil, the driving force can be generated near the shaft, allowing the holder to be driven stably. Second, the magnetic force can be easily applied to the holder to press it against the shaft.

In this lens driving device, the magnet is preferably arranged not to surround the holder but to sandwich the shaft in the holder, and the base has only one shaft. The reduced numbers of magnets and shaft contribute to a decrease in the number of components, and therefore, to a decrease in the cost and size of the lens driving device.

According to a second aspect, a camera module includes the lens driving device according to the first aspect; an image pickup device for receiving light collected by the lens; and a controller for applying a control signal to the coil of the lens driving device.

The camera module according to the second aspect provides the same effect as the lens driving device of the first aspect.

As described above, a lens driving device prevents the holder from tilting while driving a lens, and has fewer components, lower cost, and smaller size than conventional devices. A camera module including the lens driving device is also described.

### BRIEF DESCRIPTION OF DRAWINGS

FIG. 1 is an exploded perspective view of a lens driving device according to an embodiment.

FIG. 2A shows a holder of the lens driving device according to the embodiment.

FIGS. 2B and 2C show a base of the lens driving device according to the embodiment.

FIGS. 3A and 3B are perspective views showing how the holder is accommodated in the base in the lens driving device according to the embodiment.

FIGS. 4A and 4B are top views showing the positional relationship between the holder and the base of the lens driving device according to the embodiment.

FIG. 5 is an assembled view of the lens driving device according to the embodiment.

FIG. 6A is a perspective view of the lens driving device according to the embodiment.

FIG. 6B is a sectional view taken along a line A-A′ of FIG. 6A.

FIG. 7A is another perspective view of the lens driving device according to the embodiment.

FIG. 7B is a sectional view taken along a line B-B′ of FIG. 7A.

FIGS. 8A and 8B show the relationship between forces applied to magnetic plates of the lens driving device according to the embodiment.

FIGS. 9A to 9D show torques which occur in the holder of the lens driving device according to the embodiment.

FIGS. 10A and 10B show the operation of the lens driving device according to the embodiment.

FIG. 11 shows a structure of a camera module according to the embodiment.

FIGS. 12A to 12C show a modified example of the lens driving device according to the embodiment.

FIGS. 13A and 13B show another modified example of the lens driving device according to the embodiment.

### DETAILED DESCRIPTION

An embodiment will be described as follows with reference to the accompanied drawings. For convenience, no lens is illustrated in these drawings.

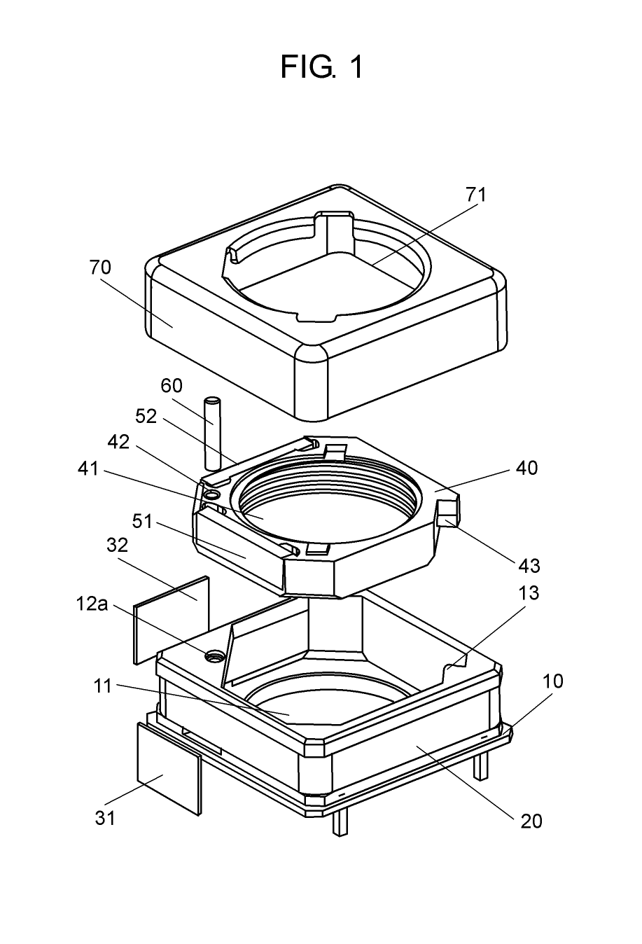

FIG. 1 is an exploded perspective view of a lens driving device according to the embodiment.

In FIG. 1, the lens driving device includes base 10, coil 20, magnetic plates 31, 32, holder 40, magnets 51, 52, shaft 60, and cover 70.

Coil 20 is wound around the side surfaces of base 10 in one direction. Magnets 51 and 52 are arranged on two side surfaces, respectively, of holder 40. Holder 40 has hole 42, and shaft 60 has a circular cross section whose diameter is slightly smaller than the inner diameter of hole 42.

Cover 70 is shaped like a bottomless box, and has opening 71 in its top surface to allow light to pass through. When viewed two dimensionally, cover 70 is a square with chamfered corners, and has a contour substantially identical to that of base 10. The inside surfaces of cover 70 are substantially identical to the portions of base 10 where coil 20 and magnetic plates 31, 32 are arranged.

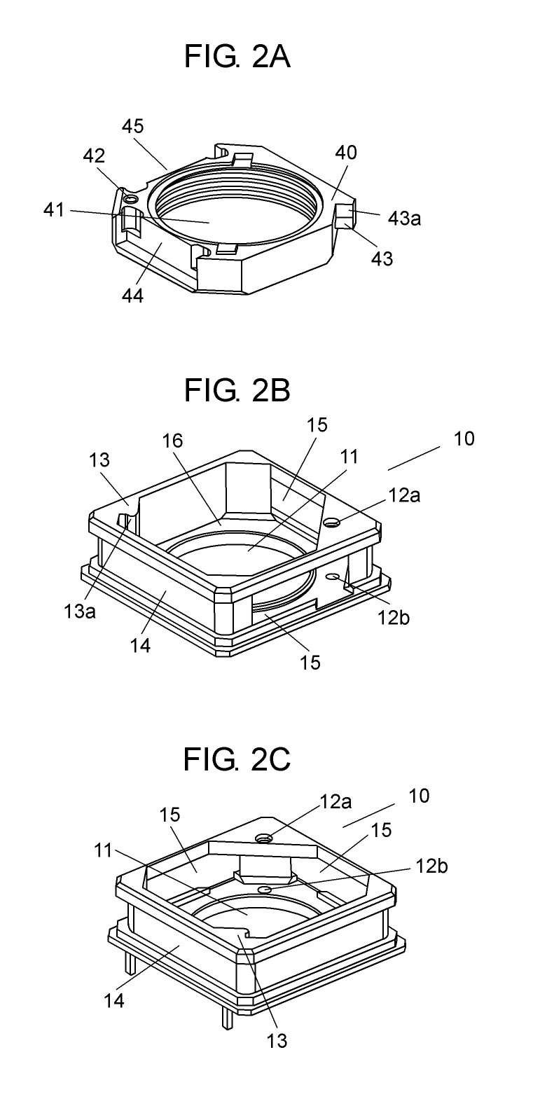

FIGS. 2B and 2C are perspective views of base 10 when it is rotated about 180 degrees and about 90 degrees, respectively, in a clockwise direction from the state shown in FIG. 1.

As shown in FIGS. 2B and 2C, base 10 is a square with chamfered corners when viewed two dimensionally. Base 10 has, at its center, opening 11 for guiding light which has passed through the lens to an image sensor. Base 10 also has holes 12a, 12b, and projection 13 (second contact part, second projection) which are located in diagonal positions. Holes 12a and 12b are vertically aligned to insert shaft 60. Projection 13 has a hook-shaped cross section, and extends between the top surface and bottom surface 16 of base 10. Projection 13 has tip 13a rounded like an arc.

Base 10 includes, over its side surfaces, coil mounting part 14 around which coil 20 is wound. Coil mounting part 14 has opening 15 at which coil 20 faces two magnets 51 and 52 arranged on holder 40.

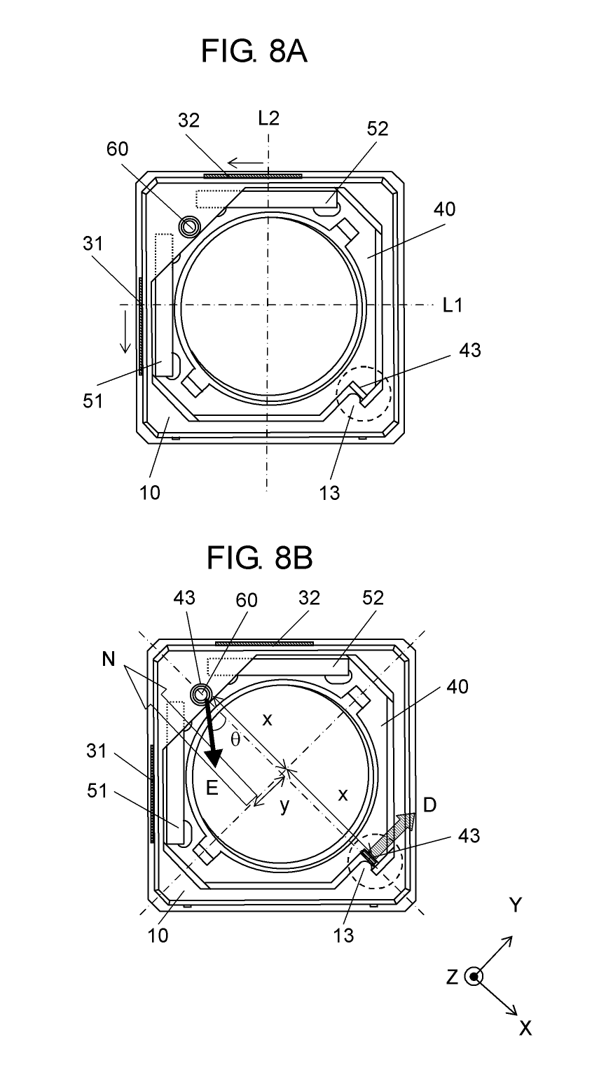

In base 10, coil 20 is wound around coil mounting part 14, and magnetic plates 31, 32 shown in FIG. 1 are adhesively bonded to the outside surface of wound coil 20. Magnetic plates 31 and 32 are bonded to outside surfaces of coil 20 to sandwich holes 12a and 12b. Magnetic plates 31 and 32 are identical in size and material. How to arrange magnetic plates 31 and 32 will be described later with reference to FIGS. 8A and 8B.

FIG. 2A is a perspective view of holder 40.

Holder 40 is a substantially octagonal frame when viewed two dimensionally. Holder 40 has, at its center, circular opening 41 for accommodating a lens barrel. Holder 40 also includes hole 42 and rotation inhibitor 43 (first contact part, first projection) which are located in diagonal positions. Hole 42 is provided to insert shaft 60. Rotation inhibitor 43, which comes into contact with projection 13 of base 10, is formed under wall surface 43a so as to project therefrom. Rotation inhibitor 43 has a semicircular vertical cross section.

Holder 40 includes magnet mounting parts 44 and 45 on which to mount magnets 51 and 52. Magnet mounting parts 44 and 45 are arranged on the two side surfaces of holder 4 so as to sandwich hole 42 and to be equally distant from hole 42. Magnets 51 and 52 shown in FIG. 1 are fitted into and adhesively bonded to magnet mounting parts 44 and 45, respectively.

Magnets 51 and 52, which can be sintered neodymium magnets, have a single-pole structure where N-pole is magnetized on one side. Magnets 51 and 52 are identical in size and magnetic intensity.

To assemble the lens driving device, first, magnets 51 and 52 are arranged on magnet mounting parts 44 and 45 of holder 40 shown in FIG. 2A. Coil 20 is wound around coil mounting part 14 of base 10. Then, holder 40 is accommodated in the frame of base 10 from above.

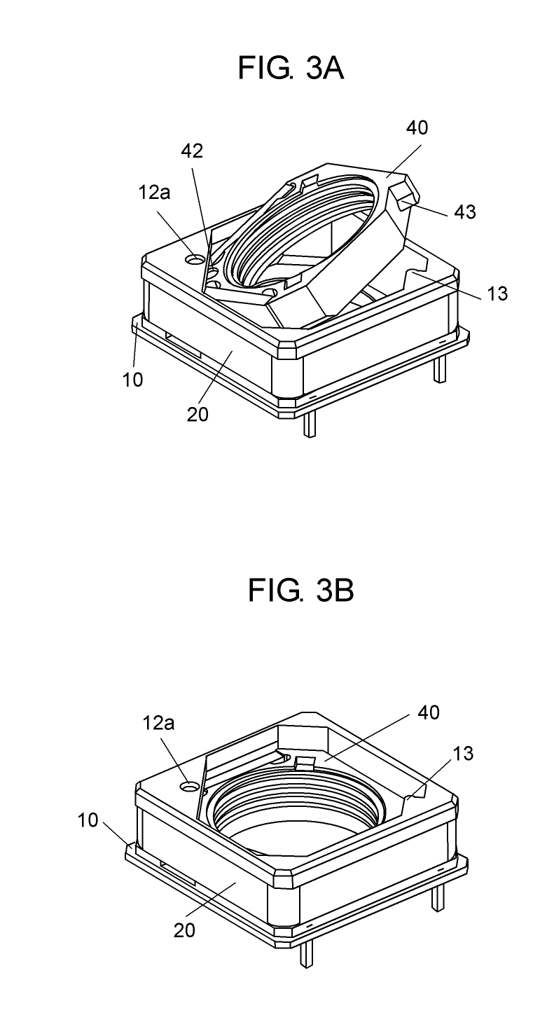

FIG. 3A is a perspective view showing holder 40 which is being accommodated in base 10.

As shown in FIG. 3A, holder 40 is tilted and inserted into base 10 from above such that hole 42 of holder 40 is aligned with hole 12a of base 10. When holder 40 is in base 10, rotation inhibitor 43 of holder 40 faces projection 13 of base 10.

FIG. 3B shows holder 40 accommodated in base 10. A tip of shaft 60 is first pressed into hole 12a of base 10, then into hole 42 of holder 40, and into hole 12b (see FIGS. 2B and 2C) of base 10. In this situation, the upper and bottom ends of shaft 60 are supported by holes 12a and 12b, respectively. Thus, shaft 60 is completely attached to base 10.

After shaft 60 is thus attached, holder 40 accommodated in base 10 is adjusted so as to be displaced along the optical axis of the lens. In this situation, rotation inhibitor 43 of holder 40 faces projection 13 of base 10.

Next, magnetic plates 31 and 32 are bonded to outside surfaces of coil 20 so as to sandwich holes 12a and 12b. When magnetic plates 31 and 32 are thus arranged, magnetic forces are generated between magnetic plates 31, 32 and magnets 51, 52. The magnetic forces bias holder 40 in a direction perpendicular to the optical axis of the lens. As a result, hole 42 of holder 40 is pressed against shaft 60.

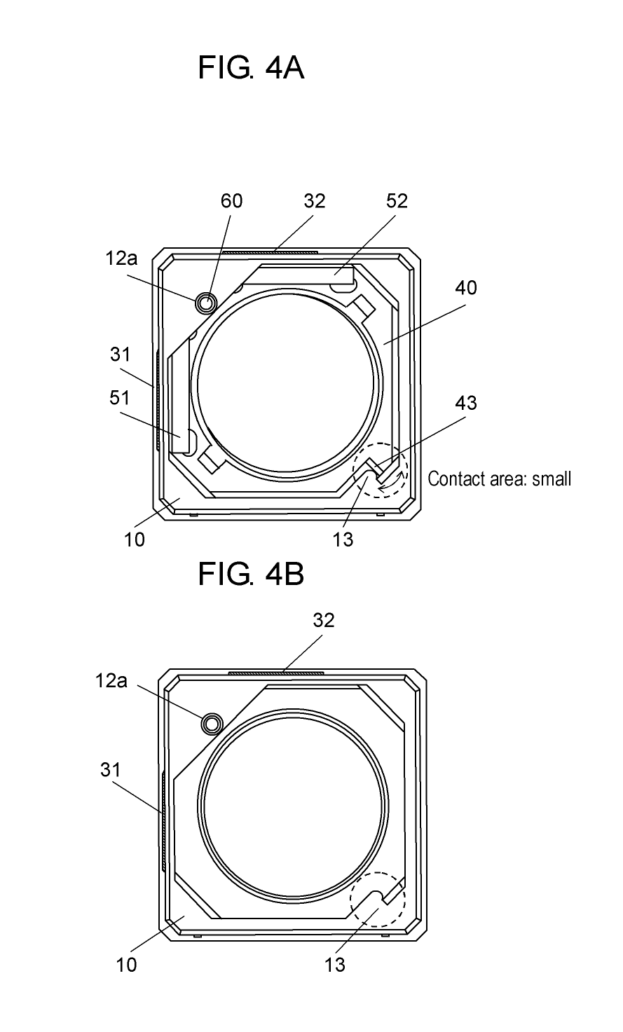

FIGS. 4A and 4B show the positional relationship between holder 40 and base 10 when the lens driving device is thus assembled. FIG. 4A is a top view of base 10 provided with holder 40 and magnetic plates 31, 32. FIG. 4B is a top view of base 10 from which holder 40 has been removed.

When holder 40 is accommodated in base 10 as shown in FIG. 4A, there is a slight gap between holder 40 and the inside surfaces of base 10. The gap causes holder 40 to be slightly rotated and displaced around shaft 60 depending on how much gravity is pulling on holder 40, thereby driving the lens unstably.

In the present embodiment, the arrangement of two magnetic plates 31 and 32 can be adjusted to make holder 40 subjected to a low torque in a clockwise direction of FIG. 4B by the magnetic forces generated between magnetic plates 31, 32 and magnets 51, 52. This torque allows rotation inhibitor 43 of holder 40 to be slightly pressed against projection 13 of base 10. Rotation inhibitor 43 of holder 40, which has a semicircular cross section, comes into point contact with hook-shaped projection 13 of base 10. The contact area between rotation inhibitor 43 and projection 13 is extremely small, allowing the frictional force generated between them to be extremely small.

When rotation inhibitor 43 is pressed against projection 13, magnets 51 and 52 are in parallel with magnetic plates 31 and 32, respectively. The distance between magnet 51 and magnetic plate 31 becomes identical to the distance between magnet 52 and magnetic plate 32.

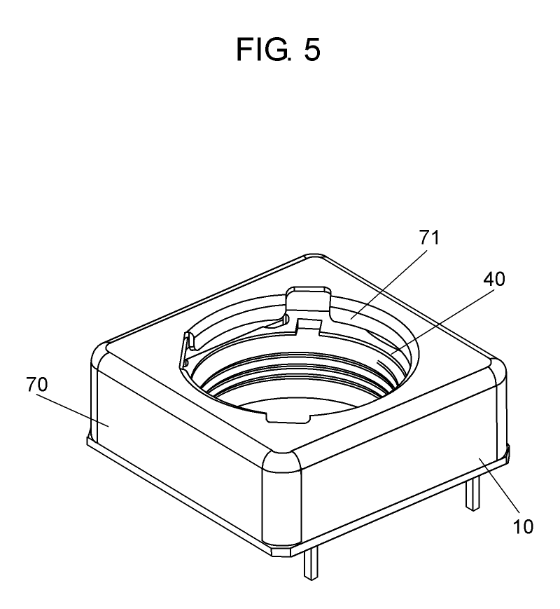

After holder 40 is accommodated in base 10, and magnetic plates 31 and 32 are arranged on outside surfaces of coil 20, cover 70 is attached to base 10 from above as shown in FIG. 1. This results in the completion of the assembly of the lens driving device shown in FIG. 5.

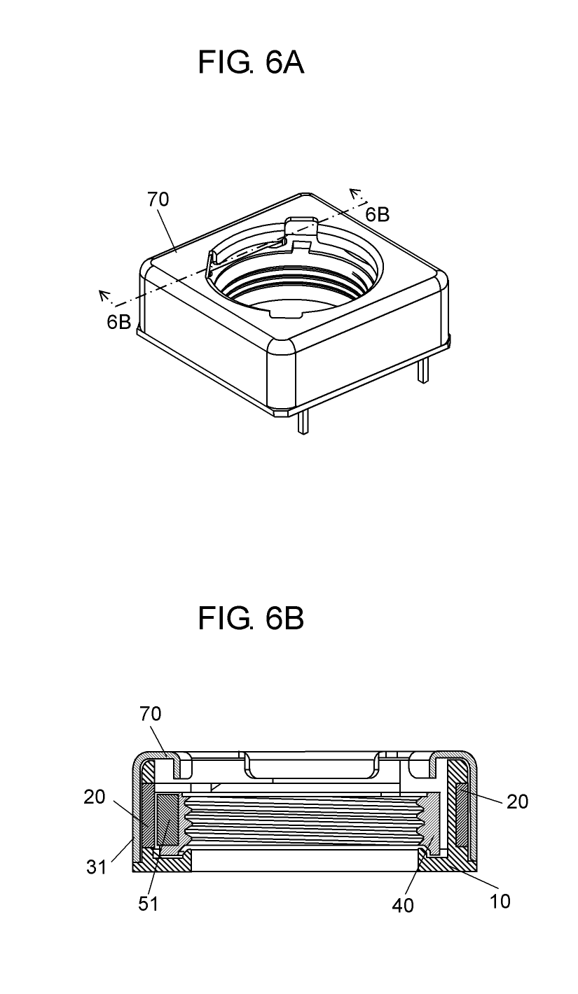

FIGS. 6A and 6B show the positional relationship between coil 20, magnetic plate 31, and magnet 51 when the lens driving device has been assembled. FIG. 6A is a perspective view of the assembled lens driving device, and FIG. 6B is a sectional view taken along a line 6B-6B of FIG. 6A.

As shown in FIG. 6B, magnet 51 is arranged on a side surface of holder 40. Coil 20 is wound around base 10 so as to face the outside surface of magnet 51. Magnetic plate 31 is bonded to a side surface of coil 20. When a current is applied to coil 20, a vertical driving force is generated by the relationship between the current and the magnetic force of magnet 51.

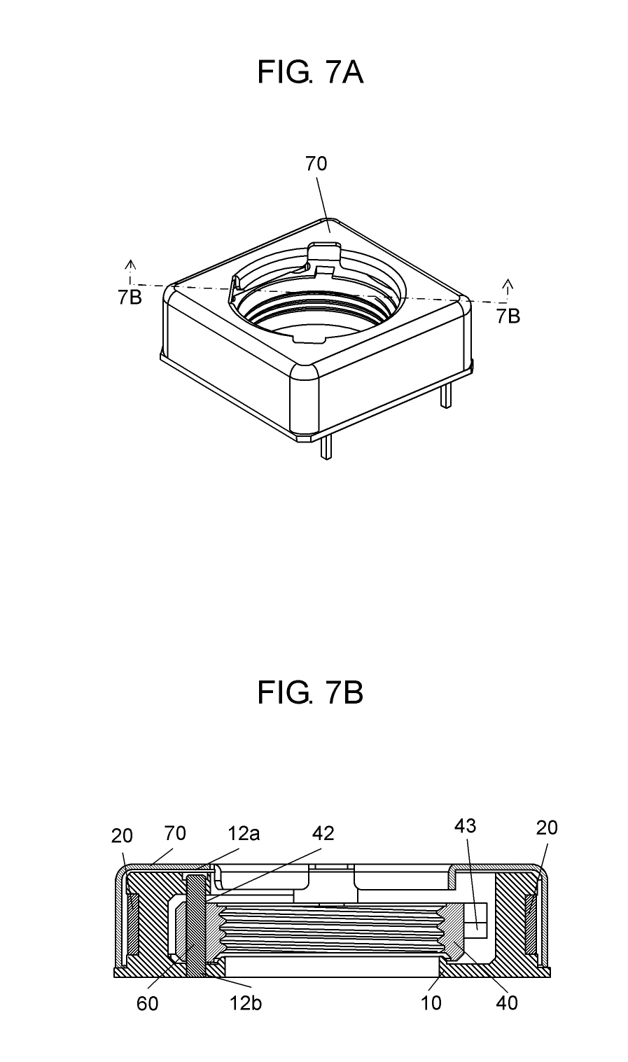

FIGS. 7A and 7B show the positional relationship between holder 40, rotation inhibitor 43, and shaft 60 when the lens driving device has been assembled. FIG. 7A is a perspective view of the assembled lens driving device, and FIG. 7B is a sectional view taken along a line B-B′ of FIG. 7A.

As shown in FIG. 7B, shaft 60 is pressed into holes 12a, 12b of base 10, and hole 42 of holder 40.

Rotation inhibitor 43 is located in a position diagonal to hole 42 of holder 40. Holder 40 can be rotated around shaft 60, but is restricted in its rotation when rotation inhibitor 43 comes into contact with projection 13 of base 10. To prevent the generation of unnecessary frictional force, the surface of rotation inhibitor 43 other than projection 13 of base 10 does not come into contact with the inside surfaces of base 10.

There is another slight gap between the upper surface of holder 40 having shaft 60, and base 10 facing the upper surface. This gap allows holder 40 to be displaced along the optical axis of the lens.

As described hereinbefore, the lens driving device of the present embodiment, which needs one shaft 60 and two magnets 51 and 52, has a small number of components, and hence, a compact size.

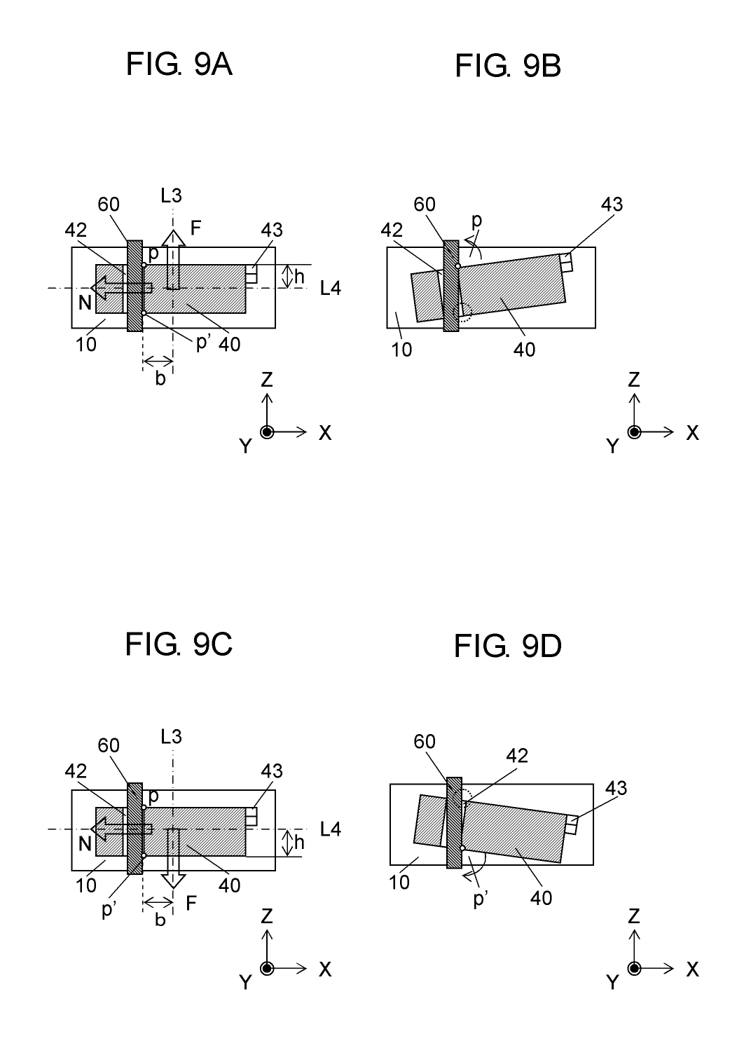

FIGS. 8A, 8B, and 9A to 9D show the effect of the arrangement of magnetic plates 31 and 32. When viewed two dimensionally, magnets 51 and 52 have centers L1 and L2, respectively.

In FIG. 8A, when viewed two dimensionally, magnetic plate 31 is located such that its center is further from shaft 60 than the center L1 of magnet 51 is. Magnetic plate 32 is located such that its center is closer to shaft 60 than the center L2 of magnet 52 is. Magnetic plates 31 and 32 are located within the pole face of magnets 51 and 52.

The magnetic forces between magnetic plates 31, 32 and magnets 51, 52 make holder 40 subjected to a force perpendicular to the optical axis of the lens. This allows holder 40 to be pressed against shaft 60 as described above. As a result, when the current application to coil 20 is stopped, holder 40 can be fixed at the position.

FIG. 8B shows the relationship between forces which are generated in the in-plane direction perpendicular to the optical axis of the lens. The forces include a resultant N and drags E and D. The resultant N corresponds to the magnetic forces generated between magnetic plates 31, 32 and magnets 51, 52. The drag E is generated in shaft 60 when holder 40 is pressed against shaft 60 by the resultant N. The drag D is generated in rotation inhibitor 43. The distance between the center of holder 40 and rotation inhibitor 43, and the distance between the center of holder 40 and the edge of hole 42 on which the drag E is applied is referred to as “x”.

Since magnetic plates 31 and 32 are located eccentrically, the center of the resultant N of the magnetic forces is displaced in the Y-axis negative direction by a distance “y” from the center of holder 40. As a result, the drag E which is generated when holder 40 is pressed against shaft 60 by the resultant N has an angle “θ” in a clockwise direction with respect to shaft 60. The force of the drag E in the X-axis direction is represented by E cos θ, whereas the force of the drag E in the Y-axis direction is represented by E sin θ.

The equilibrium of the forces in the X coordinate is calculated by using

N=E cos θ formula (1).

The equilibrium of the forces in the Y coordinate is calculated by using

D=E sin θ formula (2).

The torque generated around holder 40 in the clockwise and counter-clockwise directions are represented by Ny and (E sin θ+D)x, respectively.

The equilibrium of the torques is calculated by using

Ny=(E sin θ+D)x formula (3).

From formulas (1) to (3), the dimension of y and x are represented by using

tan θ=y/2x formula (4).

In the formula (2), the drag D, which is generated in rotation inhibitor 43, decreases with a decrease in the angle θ. The angle θ decreases with a decrease in the difference between the distance between shaft 60 and magnetic plate 31 and the distance between shaft 60 and magnetic plate 32. In other words, the angle θ can be controlled by adjusting the positions of magnetic plates 31 and 32 with respect to shaft 60, thereby adjusting the ratio of the drag E to the drag D to, for example, about 10:1. This markedly reduces the drag D applied to rotation inhibitor 43, thereby reducing the frictional force applied to rotation inhibitor 43. In addition, since rotation inhibitor 43 and hook-shaped projection 13 of base 10 comes into point contact with each other, the frictional force generated in rotation inhibitor 43 is extremely small.

As a result, in the present embodiment, when a current is applied to coil 20, holder 40 can move smoothly.

FIGS. 9A to 9D are internal perspective views of the lens driving device when seen in the line 7B-7B of FIG. 7A. These drawing schematically show the relationship between forces generated along the lens optical axis when the lens is driven.

FIG. 9A shows holder 40 which is subjected to an upward driving force F when a current is applied to coil 20. In FIG. 9A, the center of holder 40 is represented by lines L3 and L4. Hole 42 of holder 40 and shaft 60 are slightly spaced from each other in order to drive holder 40.

Holder 40 is subjected not only to the driving force F, but also to the resultant N corresponding to the magnetic forces shown in FIG. 8B. The resultant N allows hole 42 of holder 40 to be pressed at its inside surface (the right-side surface in FIG. 9A) against shaft 60. A fulcrum “p” is set to the upper end of the inside of hole 42. The distance between the fulcrum p and the driving force F is referred to as “b”, and the distance between the fulcrum p and the resultant N is referred to as “h”. Therefore, the counter-clockwise and clockwise torques which are generated around the fulcrum p become Fb and Nh, respectively. If the counter-clockwise torque is larger than the clockwise torque, satisfying a relation of Fb−Nh>0, the gap between shaft 60 and hole 42 causes holder 40 to be tilted upward on its rotation inhibitor 43 side as shown in FIG. 9B. In this case, the tilting of holder 40 can be prevented by satisfying a relation of Fb−Nh≦0.

When, on the other hand, a fulcrum p′ is set to the bottom end of the inside of hole 42, the two torques generated by the resultant N and the driving force F are both counter-clockwise, and press the inner surface of hole 42 against shaft 60. As a result, holder 40 is not tilted around the fulcrum p′. Thus, when holder 40 is subjected to the upward driving force F, the tilting of holder 40 can be reduced by setting the driving force F, the resultant N, and the distances b and h to satisfy the relation of Fb−Nh≦0.

FIG. 9C shows holder 40 which is subjected to a downward driving force F when a current is applied to coil 20. In this case, the clockwise and counter-clockwise torques which are generated around the fulcrum p′ become Fb and Nh, respectively. If the clockwise torque is larger than the counter-clockwise torque, satisfying the relation of Fb−Nh>0, the gap between shaft 60 and hole 42 causes holder 40 to be tilted downward on its rotation inhibitor 43 side as shown in FIG. 9D. In this case, the tilting of holder 40 can be prevented by satisfying the relation of Fb−Nh≦0.

In contrast, when the fulcrum p is set to the upper end of the inside of hole 42, the two torques generated by the resultant N and the driving force F are both clockwise, and press the inner surface of hole 42 against shaft 60. As a result, holder 40 is not tilted around the fulcrum p. Thus, when holder 40 is subjected to the downward driving force F, the tilting of holder 40 can be reduced by setting the driving force F, the resultant N, and the distances b and h to satisfy the relation of Fb−Nh≦0.

Considering these relations, the clockwise and counter-clockwise tilts of holder 40 can be reduced by adjusting the magnetic forces generated between magnetic plates 31, 32 and magnets 51, 52 so as to satisfy the relation of Fb−Nh≦0 where F is an upward or downward maximum driving force applied to holder 40. This adjustment allows the lens to be driven stably with the use of only one shaft 60.

Although it is ignored in the above description, the reduction of tilt has to be actually determined considering the forces of gravity acting on the lens and the holder. In this case, the driving force F, the resultant N, the distances b and h have to be set such that the torque Fb is smaller than the torque Nh.

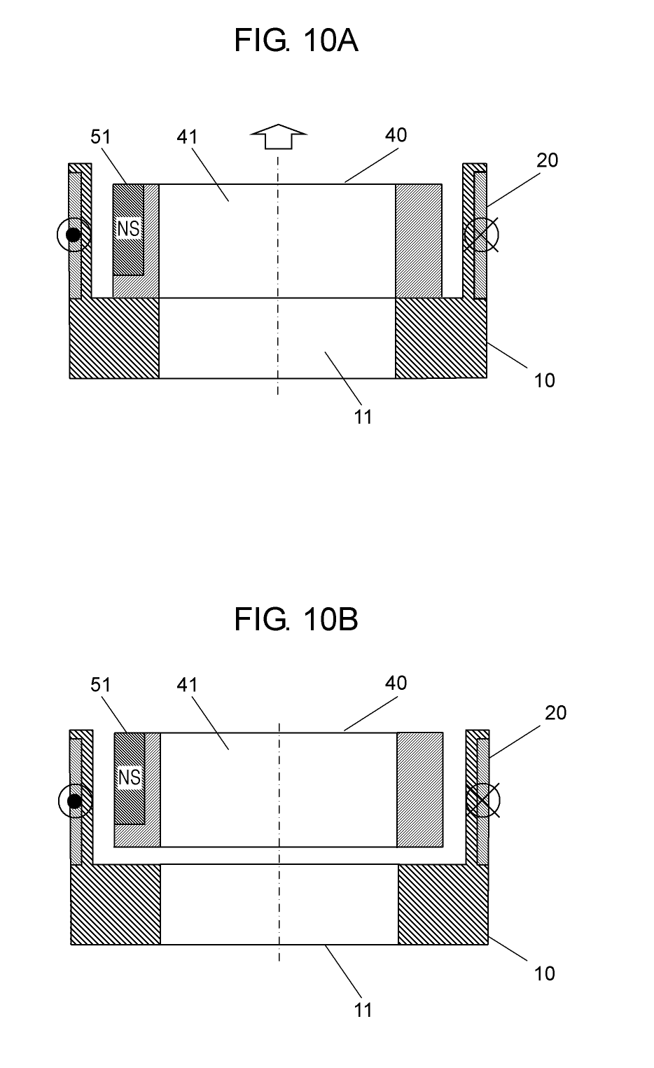

FIGS. 10A and 10B show the operation of the lens driving device. FIG. 10A is a schematic sectional view taken along the line 6B-6B of FIG. 6A. In FIGS. 10A and 10B, the symbol with a circle and a black dot in the center represents the direction of a current flowing to the front side of the drawings. The symbol with a circle and a cross on it represents the direction of a current flowing to the rear side of the drawings.

As shown in FIGS. 10A and 10B, coil 20 faces the N pole of magnet 51. When a current is applied in the direction shown in FIG. 10A to coil 20, an upward driving force is applied to magnet 51, displacing holder 40 upward as shown in FIG. 10B. If the current application is stopped at this moment, the magnetic forces between magnetic plates 31, 32 and magnets 51, 52 press holder 40 against shaft 60. As a result, holder 40 is fixed at the position. If a current is applied in the opposite direction to coil 20 at the state of FIG. 10B, holder 40 is displaced downward.

Holder 40 is displaced upward or downward in this manner, allowing the lens to be fixed at the on-focus position. Holder 40 has a home position where the bottom surface of holder 40 comes into contact with base 10.

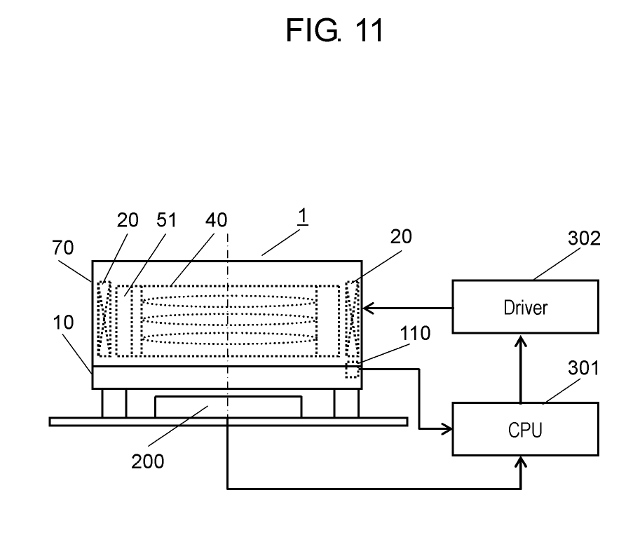

FIG. 11 shows a schematic structure of a camera module equipped with the above-described lens driving device 1.

The camera module includes image sensor 200 under base 10. Base 10 includes Hall element 110 as a position sensor, which outputs a signal for detecting the position of holder 40.

The camera module further includes CPU (Central Processing Unit) 301 and driver 302. During focusing, CPU 301 controls driver 302 such that holder 40 is displaced from the home position to a predetermined position along the optical axis of the lens. Hall element 110 transmits the position detection signal to CPU 301. At the same time, CPU 301 processes a signal received from image sensor 200 so as to calculate a contrast value of a captured image, and to determine, as an on-focus position, the position of holder 40 that optimizes the contrast value.

Then, CPU 301 drives holder 40 to the determined on-focus position. In this case, CPU 301 drives holder 40 while monitoring the signal from Hall element 110 until it corresponds to the on-focus position. As a result, holder 40 is fixed at the on-focus position.

As described hereinbefore, in the present embodiment, holder 40 moves along shaft 60 while being pressed against it, becoming less likely to be tilted than in the case of moving along two shafts. As described with reference to FIGS. 9A to 9D, the tilting of holder 40 while it is driven along the lens optical axis can be reduced by adjusting the magnetic forces generated between magnetic plates 31, 32 and magnets 51, 52. As a result, the lens driving device drives the lens stably.

In the present embodiment, the rotation of holder 40 is restricted by slightly pressing rotation inhibitor 43 against projection 13 like a point contact, thereby markedly reducing the frictional force generated in rotation inhibitor 43. More specifically, when holder 40 moves in a direction parallel to the optical axis of the lens, rotation inhibitor 43 and projection 13 are brought into and maintained in point contact with each other, thereby markedly reducing the frictional force during the movement of holder 40. Thus, in the present embodiment, the influence of the contact between rotation inhibitor 43 and projection 13 on the movement of holder 40 can be reduced to an ignorable level. As a result, the lens driving device drives the lens stably.

In the present embodiment, magnets 51 and 52 are arranged so as to sandwich shaft 60. Therefore, when a current is applied to coil 20, the driving force can be generated near shaft 60, allowing holder 40 to be driven stably. In addition, the magnetic forces can be easily applied to holder 40 to press it against shaft 60.

In the present embodiment, holder 40 includes two magnets 51 and 52, and base 10 includes only one shaft. Therefore, the lens driving device can have fewer components, lower cost, and smaller size than conventional devices.

It should be noted that the above-described embodiment can be variously modified.

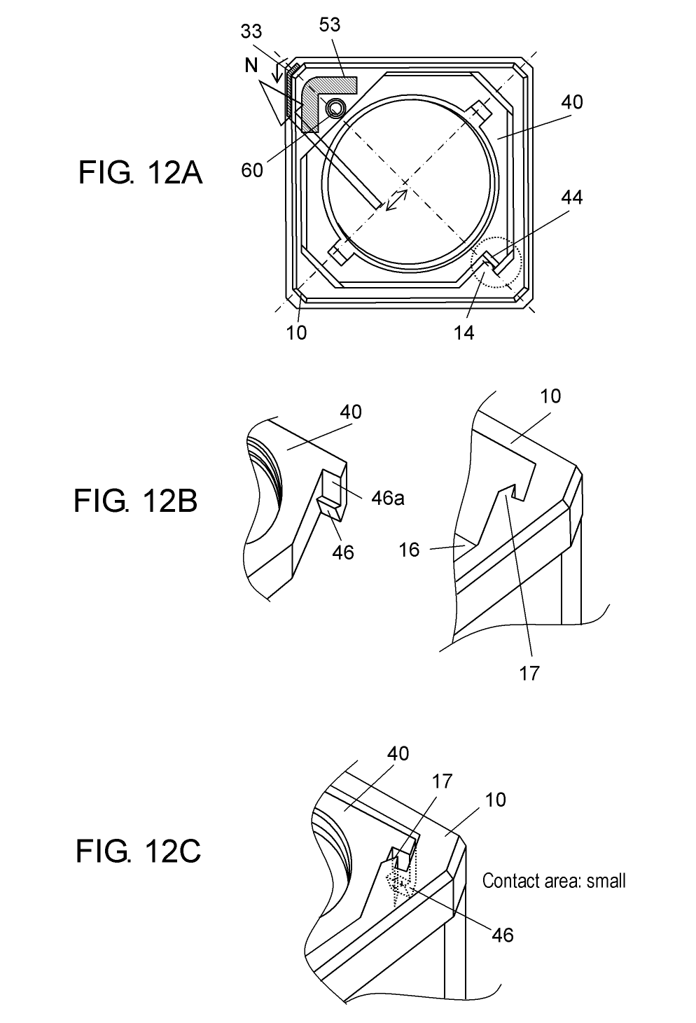

For example, two magnets 51 and 52 are located on side surfaces of holder 40, and magnetic plates 31 and 32 are located eccentrically outside magnets 51 and 52 in the embodiment. Alternatively, as shown in FIG. 12A, it is possible to locate one arc- or square-shaped magnet 53 on the side surfaces of holder 40 on which shaft 60 is arranged, and to eccentrically locate magnetic plate 33 outside magnet 53.

In this case, in the same manner as in the above described embodiment, the magnetic force N generated between magnetic plate 33 and magnet 53 is off the center of holder 40, thereby generating a clockwise torque. When a current is applied to coil 20, holder 40 can move smoothly. The magnitude of the magnetic force N can be adjusted to reduce the tilt caused when the lens driving device drives the lens.

The lens driving device of this modified example, which needs only one magnet 53 and one magnetic plate 33, can have fewer components and smaller size than the lens driving device of the embodiment.

In the present embodiment, in order to restrict the rotation of holder 40, base 10 includes projection 13 having a hook-shaped cross section and a rounded tip 13, and holder 40 includes rotation inhibitor 43 having a semicircular vertical cross section. Alternatively, as shown in FIG. 12B, base 10 may include projection 17 having a triangular cross section, and holder 40 may include rotation inhibitor 46 having a triangular vertical cross section. In this case, projection 17 extends between the top surface and bottom surface 16 of base 10. Rotation inhibitor 46 is formed under wall surface 46a so as to project therefrom.

In this case, as shown in FIG. 12C, the contact area between projection 17 and rotation inhibitor 46 is small, allowing the frictional force generated between them to be extremely small as in the above-described embodiment. Therefore, when a current is applied to coil 20, holder 40 can move smoothly. In this modified example, both projection 17 and rotation inhibitor 46 have pointed tips, but either one of them may have a rounded tip as in the above-described embodiment. Projection 13 and rotation inhibitor 43 preferably have rounded tips to move holder 40 smoothly along the optical axis of the lens.

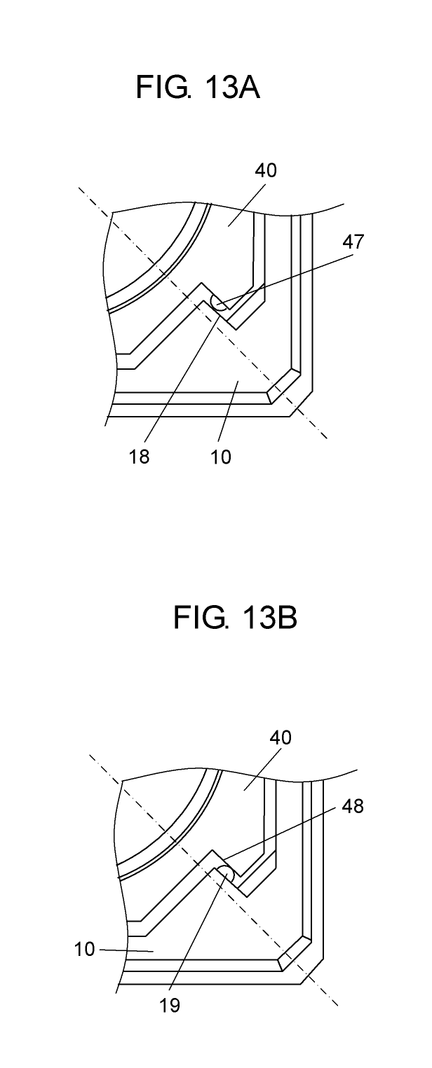

Alternatively, as shown in FIG. 13A, holder 40 may include hemispherical projection 47 (first contact part), and base 10 may include planar wall part 18 (second contact part) coming into contact with projection 47. Further alternatively, as shown in FIG. 13B, base 10 may include hemispherical projection 19 (first contact part), and holder 40 may include planer wall part 48 (second contact part) coming into contact with projection 19. Projections 47 and 19 may have any shape such as a columnar or conical shape with a rounded tip, instead of the hemispherical shape.

Both magnetic plates 31 and 32 are located eccentrically in the above embodiment, but alternatively, either one of them may be located eccentrically. Magnetic plates 31 and 32 are identical in size and material, and magnets 51 and 52 are identical in size and magnetic intensity in the above embodiment. Alternatively, however, magnetic plates 31 and 32 may be different either in size or material, or magnets 51 and 52 may be different both in size and magnetic intensity. In this case, the position of the resultant N can be shifted such that holder 40 is subjected to the torque around shaft 60.

Two magnets are arranged on two side surfaces of holder 40, and two magnetic plates are arranged on two side surfaces of coil 20 outside the magnets in the above embodiment. Alternatively, two or more magnets may be arranged on each side surface of holder 40, and two or more magnetic plates may be arranged on each side surface of coil 20 outside the magnets. In this case, as in the above-described embodiment, the magnetic plates are preferably located such that the magnetic forces generated between the magnets and the magnetic plates are imbalanced in a plane perpendicular to the optical axis of the lens, thereby subjecting the rotation inhibitor to a low torque.

The present embodiment uses magnets having a single-pole structure and one coil, but alternatively, it is possible to use magnets having a two-pole structure, and two coils.

Base 10 and holder 40 may have other shapes than those described above. Holder 40 may be guided by a guide mechanism other than shaft 60 along the optical axis of the lens.

As described hereinbefore, the lens driving device of the present embodiment includes a base; a shaft arranged on the base; a holder for holding a lens, the holder being supported by the shaft so as to be displaced in a direction parallel to the optical axis of the lens; a magnet arranged on the holder so as to sandwich the shaft; a coil arranged on the base so as to face the magnet; and a magnetic plate arranged on the base so as to face the magnet with the coil therebetween. The holder includes a first contact part, and the base includes a second contact part, the first and second contact parts coming into contact with each other in a direction where the holder rotates around the shaft. The magnetic plate is located such that the holder is subjected to a torque on the shaft by a magnetic force generated between the magnet and the magnetic plate, the torque being applied in a direction where the first contact part is pressed against the second contact part.

In this lens driving device, the holder moves along one shaft, becoming less likely to be tilted than in the case of moving along two shafts. The magnets are arranged to sandwich the shaft, which has two merits. First, when a current is applied to the coil, the driving force can be generated near the shaft, allowing the holder to be driven stably. Second, the magnetic force can be easily applied to the holder to press it against the shaft.

The magnets are arranged not to surround the holder but to sandwich the shaft in the holder, and the base includes only one shaft. Thus, the lens driving device has fewer components, lower cost, and smaller size than conventional devices.

In the lens driving device of the present embodiment, the first and second contact parts may be brought into and maintained in point contact with each other when the holder moves in a direction parallel to the optical axis. With this structure, the first and second contact parts come into point contact with each other when the holder moves, thereby markedly reducing the frictional force generated therebetween. This markedly reduces the influence of the frictional force between the first and second contact parts on the movement of the holder. As a result, the lens driving device drives the lens stably.

With this structure, the first and second contact parts may be a first projection and a second projection, respectively, which are contiguously formed in a direction perpendicular to the optical axis. The second projection is formed at least in a range including the travel limit of the holder. As a result, the first and second projections can easily come into point contact with each other.

In this case, the tips of the first and second projections can be rounded in the directions parallel and perpendicular, respectively, to the optical axis. The two rounded tips come into contact with each other, allowing the holder to move smoothly. The first and second projections slide with each other at the rounded tips, thereby reducing abrasion due to sliding.

In the lens driving device of the present embodiment, two magnets are arranged on two side surfaces sandwiching the shaft in the holder. Therefore, the holder needs only two magnets, allowing one magnet to be arranged on each side surface.

In the lens driving device of the present embodiment, each magnetic plate is arranged on each of the two side surfaces which sandwich the shaft in the base. The positions of the magnetic plates are set such that the magnetic plates are differently spaced from the shaft. Therefore, the magnetic forces generated between the magnets and the magnetic plates can make the holder subjected to a torque generated on the shaft by only adjusting the arrangement of the magnetic plates. This can avoid unnecessary rotation of the holder.

The embodiment of the present invention can be modified variously within the scope of the claims.

What is claimed is:

1. A lens driving device comprising:
a base;
a shaft arranged on the base;
a holder for holding a lens, the holder being supported by the shaft so as to be displaced in a direction parallel to an optical axis of the lens;
a magnet arranged on the holder so as to sandwich the shaft;
a coil arranged on the base so as to face the magnet; and
a magnetic plate arranged on the base so as to face the magnet with the coil therebetween, wherein
the holder includes a first contact part, and the base includes a second contact part, the first and second contact parts coming into contact with each other in a direction where the holder rotates around the shaft, and
the magnetic plate is located such that the holder is subjected to a torque on the shaft by a magnetic force generated between the magnet and the magnetic plate, the torque being applied in a direction where the first contact part is pressed against the second contact part.

2. The lens driving device of claim 1, wherein
the first contact part and the second contact part are brought into and maintained in point contact with each other when the holder moves in the direction parallel to the optical axis.

3. The lens driving device of claim 2, wherein
the first contact part is a first projection contiguously formed in a direction perpendicular to the optical axis;
the second contact part is a second projection contiguously formed in the direction perpendicular to the optical axis; and
the second projection is formed at least within a movement range of the holder.

4. The lens driving device of claim 3, wherein
the first projection has a tip rounded in the direction parallel to the optical axis; and
the second projection has a tip rounded in the direction perpendicular to the optical axis.

5. The lens driving device of claim 4, further comprising a plurality of the magnets, wherein:
the holder has two side surfaces that sandwich the shaft; and
one of the magnets is arranged on each of the two side surfaces.

6. The lens driving device of claim 5, further comprising a plurality of the magnetic plates, wherein
each of the magnetic plates is arranged on each of the two side surfaces sandwiching the shaft of the base such that the magnetic plates are differently spaced from the shaft.

7. A camera module comprising:
the lens driving device of claim 6;
an image pickup device for receiving light collected by the lens; and
a controller for applying a control signal to the coil of the lens driving device.

8. The lens driving device of claim 1, further comprising a plurality of the magnets, wherein:
the holder has two side surfaces that sandwich the shaft; and
one of the magnets is arranged on each of the two side surfaces.

9. The lens driving device of claim 1, further comprising a plurality of the magnetic plates, wherein
each of the magnetic plates is arranged on each of the two side surfaces sandwiching the shaft of the base such that the magnetic plates are differently spaced from the shaft.

10. A camera module comprising:
the lens driving device of claim 1;
an image pickup device for receiving light collected by the lens; and
a controller for applying a control signal to the coil of the lens driving device.
